(19) United States
(12) Patent Application Publication
(10) Pub. No.: US 2024/0270581 A1
(43) Pub. Date: Aug. 15, 2024

(54) DRY ICE PREPARATION DEVICE, AND AIR EXHAUST STRUCTURE AND AIR EXHAUST METHOD FOR DRY ICE PREPARATION DEVICE

(71) Applicant: XIAMEN JIN RUI YI INDUSTRIAL & TRADING CO., LTD., Xiamen (CN)

(72) Inventors: Qi LIN, Xiamen (CN); Tongying SHI, Xiamen (CN)

(21) Appl. No.: 18/648,082

(22) Filed: Apr. 26, 2024

Related U.S. Application Data
(63) Continuation-in-part of application No. PCT/CN2023/072777, filed on Jan. 18, 2023.

(30) Foreign Application Priority Data
Feb. 10, 2022 (CN) 202220273869.3
Mar. 23, 2022 (CN) 202210288202.5

(51) Int. Cl. C01B 32/55; F25J 1/00

(52) U.S. Cl. CPC C01B 32/55; F25J 1/0027; F25J 2210/80

(57) ABSTRACT

A dry ice preparation device includes an ice preparation cavity, one or more ice injection valves, an air exhaust valve, and a liquid inlet pipeline. The one or more ice injection valves are disposed on a distal end of the liquid inlet pipeline and are configured to eject liquid carbon dioxide into the ice preparation cavity by turning on a liquid outlet port. The air exhaust valve is disposed between an air exhaust port and the liquid outlet port to enable the liquid outlet port to be in communication with external air through the air exhaust port.

### RELATED APPLICATIONS

This application is a continuation of International patent application PCT/CN2023/072777, filed on Jan. 18, 2023, which claims priority to Chinese patent application 202220273869.3, filed on Feb. 10, 2022, and Chinese patent application 202210288202.5, filed on Mar. 23, 2022. International patent application PCT/CN2023/072777, Chinese patent application 202220273869.3, and Chinese patent application 202210288202.5 are incorporated herein by reference.

### FIELD OF THE DISCLOSURE

The present disclosure relates to production equipment for forming dry ice, and in particular relates to an air exhaust device for dry ice preparation process.

### BACKGROUND OF THE DISCLOSURE

The existing method for preparing dry ice is as follows: decompressing liquid carbon dioxide from a storage tank through a pipeline and an electromagnetic valve to enter into a dry ice compression chamber so as to be compressed into blocks. A switch of the electromagnetic valve is set according to a compression time of a mold, and on-off duration of the electromagnetic valve is controlled by a programmable logic controller (PLC). Therefore, a large amount of carbon dioxide gas will be not completely separated from the dry ice and remain in the mold, resulting in irregular exhaustion of the carbon dioxide gas on site, resulting in huge waste of cooling capacity, and resulting in a low conversion rate of the dry ice for decompressing the liquid carbon dioxide to normal pressure.

Referring to FIGS. 1 and 2, in a dry ice preparation device in the existing techniques, in order to exhaust residual carbon dioxide gas, an outer wall of an ice preparation cavity comprises a window 7. The window 7 is filled with low-density materials, and pores of the low-density materials are used to exhaust carbon dioxide gas 10. However, during a dry ice preparation process, some of carbon dioxide particles 9 in the ice preparation cavity are compressed to form dry ice blocks 8 in the ice preparation cavity, and a large amount of the carbon dioxide particles 9 are still attached to the pores of the low-density materials in the window 7. Therefore, the pores of the low-density materials are blocked, so that the carbon dioxide gas 10 cannot be normally exhausted, resulting in an air explosion phenomenon when the dry ice is formed by compressing in the ice preparation cavity. Therefore, in order to prevent this phenomenon, a cavity for forming dry ice cannot be designed to be large, so that dry ice blocks 8 with a larger size cannot be prepared.

### BRIEF SUMMARY OF THE DISCLOSURE

The technical problem to be solved by the present disclosure is to provide a dry ice preparation device, and an air exhaust structure and an air exhaust method for dry ice preparation, and carbon dioxide gas blocked in a cavity during a dry ice preparation process can be exhausted.

A design idea of the present disclosure is to further provide an air flow passage in a dry ice forming cavity. The air flow passage is a dry ice injection passage, and a liquid outlet port is converted into a gas exhaust passage after dry ice injection is complete. When dry ice is prepared in an ice preparation cavity, residual carbon dioxide gas is exhausted through the liquid outlet port.

The present disclosure provides an air exhaust method for a dry ice preparation device comprising the follow steps.
1) enabling a liquid outlet port to be in communication with a liquid inlet pipeline, and ejecting liquid carbon dioxide into an ice preparation cavity through the liquid outlet port during dry ice preparation; and
2) blocking the liquid outlet port from the liquid inlet pipeline, and enabling the liquid outlet port to be in communication with external air when the dry ice preparation is complete.

In order to solve the above-mentioned technical problems, the present disclosure provides a dry ice preparation device. The dry ice preparation device comprises an ice preparation cavity, one or more ice injection valves, an air exhaust valve, and a liquid inlet pipeline. The one or more ice injection valves are disposed on a distal end of the liquid inlet pipeline and are configured to eject liquid carbon dioxide into the ice preparation cavity by turning on a liquid outlet port.

The air exhaust valve is disposed between an air exhaust port and the liquid outlet port to enable the liquid outlet port to be in communication with external air through the air exhaust port.

In a preferred embodiment, the one or more ice injection valves are at least two ice injection valves.

In a preferred embodiment, the one or more ice injection valves and the air exhaust valve are connected to the liquid inlet pipeline through a three-way pipe.

In a preferred embodiment, a first inlet of the three-way pipe is connected to the liquid inlet pipeline, a second inlet of the three-way pipe is connected to the air exhaust valve, an outlet of the three-way pipe is the liquid outlet port, and the one or more ice injection valves are disposed between the first inlet and the liquid outlet port.

In a preferred embodiment, the one or more ice injection valves enable the first inlet to be in communication with the liquid outlet port during ice preparation.

In a preferred embodiment, the one or more ice injection valves enable the first inlet to be blocked from the liquid outlet port, and the air exhaust valve enables the liquid outlet port to be in communication with the air exhaust port when the ice preparation is complete.

The present disclosure further provides an air exhaust structure for a dry ice preparation device, and a liquid outlet port for ejecting liquid carbon dioxide is in communication with external air through an air exhaust valve.

In a preferred embodiment, the liquid outlet port and the air exhaust valve are connected to the liquid inlet pipeline through a three-way pipe.

In a preferred embodiment, a first inlet of the three-way pipe is connected to the liquid inlet pipeline, a second inlet of the three-way pipe is connected to the air exhaust valve, an outlet of the three-way pipe is the liquid outlet port, and the one or more ice injection valves are disposed between the first inlet and the liquid outlet port.

Compared with the existing techniques, the technical solution of the present disclosure has the following advantages.

The present disclosure provides the dry ice preparation device, the air exhaust structure, and the air exhaust method of the dry ice preparation device. The air exhaust valve and an air exhaust passage are added. The liquid outlet port is in communication with external air by turning on the air exhaust valve after the dry ice preparation is complete, so that residual high-pressure carbon dioxide gas in the ice preparation cavity caused by an exhaust window being blocked by carbon dioxide particles can be in communication with external air to exhaust the residual gas. This method uses the liquid outlet port as an inlet of the air exhaust passage. The liquid outlet port is used to eject the liquid carbon dioxide during the ice preparation, no new dry ice particles are produced after the liquid carbon dioxide is turned off, so that the liquid outlet port will not be blocked. Therefore, using the liquid outlet port as the inlet of the air exhaust passage can ensure that the air exhaust passage will not be blocked.

### BRIEF DESCRIPTION OF THE DRAWINGS

FIG. 1 illustrates a cross-sectional view of a dry ice preparation device in the existing techniques.

FIG. 2 illustrates a view of the dry ice preparation device in the existing techniques at another angle.

FIG. 3 illustrates a front view of a preferred embodiment of the present disclosure.

FIG. 4 illustrates a side view of the preferred embodiment of the present disclosure.

FIG. 5 illustrates is a connection diagrammatic view of a three-way pipe of the preferred embodiment of the present disclosure.

### DETAILED DESCRIPTION OF THE EMBODIMENTS

The technical solutions in the embodiments of the present disclosure will be clearly and completely described below in combination with the accompanying drawings in the embodiments of the present disclosure. It is obvious that the described embodiments are merely some embodiments of the present disclosure instead of all embodiments. It is intended that all other embodiments fall within the protective scope of the present disclosure provided that they are made by technical person skilled in the art based on the embodiments of the present disclosure without creative works.

In the description of the present disclosure, it should be noted that an orientation or a positional relationship represented by terms, such as “upper”, “lower”, “inner”, “outer”, “top”, or “bottom”, are based on the orientation or the positional relationship shown in the drawings. It is merely used to easily describe the present disclosure and simplify the description instead of indicating or implying that a referred device or element should have a specified orientation or be constructed and operated in a specified orientation, and it should not be understood as a limitation of the present disclosure. In addition, terms “first” and “second” are merely used for description purposes and should not be understood to indicate or imply relative importance.

In the description of the present disclosure, unless otherwise expressly required and limited, it should be noted that terms, such as “installed”, “disposed”, “sleeved”, “socketed”, and “connected”, should develop broad understanding. For example, “connected” can be a wall-mountable connection, a detachable connection, or an integrated connection, a mechanical connection, an electrical connection, a direct connection, an indirect connection through an intermediator, or communication between inner portions of two members. For technical person skilled in the art, specific meaning of the terms in the present disclosure can be understood under specific conditions.

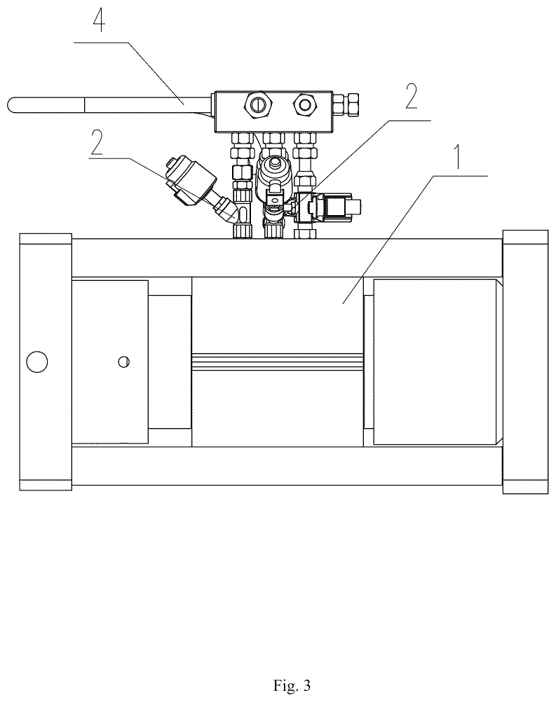

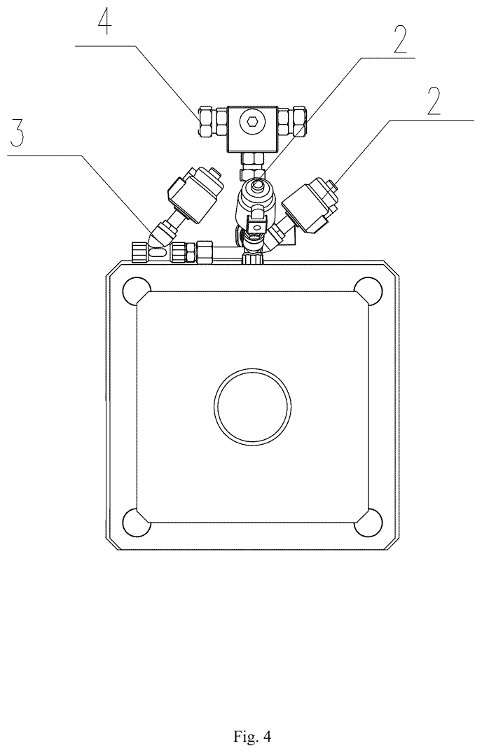

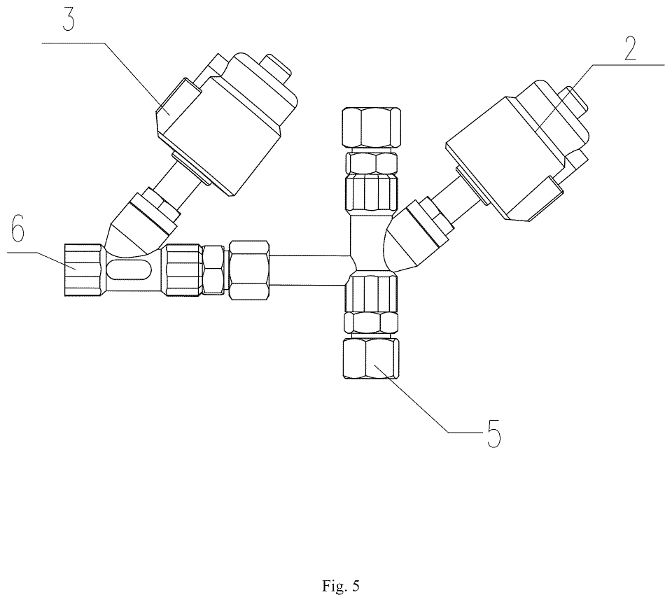

Referring to FIGS. 3-5, this embodiment provides a dry ice preparation device. The dry ice preparation device comprises an ice preparation cavity 1, one or more ice injection valves 2 (e.g., two ice injection valves), an air exhaust valve 3, and a liquid inlet pipeline 4. The one or more ice injection valves 2 are disposed on a distal end of the liquid inlet pipeline 4 and are configured to inject liquid carbon dioxide into the ice preparation cavity 1 by turning on a liquid outlet port 5.

The air exhaust valve 3 is disposed between an air exhaust port 6 and the liquid outlet port 5 to enable the liquid outlet port 5 to be in communication with external air through the air exhaust port 6.

In the dry ice preparation device, the air exhaust valve 3 is further added. Residual high-pressure carbon dioxide gas in the ice preparation cavity 1 can be in communication with the external air by turning on the air exhaust valve 3 after dry ice preparation is complete, and the residual high-pressure carbon dioxide gas is therefore exhausted.

It should be noted that a number of the one or more ice injection valves 2 can be any number, and the number is not limited to be two in this embodiment.

In order to achieve the above-mentioned pipeline arrangement, the one or more ice injection valves 2 and the air exhaust valve 3 are connected to the liquid inlet pipeline 4 through a three-way pipe. Specifically, a first inlet of the three-way pipe is connected to the liquid inlet pipeline 4, a second inlet of the three-way pipe is connected to the air exhaust valve 3, and an outlet of the three-way pipe is the liquid outlet port 5. The one or more ice injection valves 2 are disposed between the first inlet and the liquid outlet port 5.

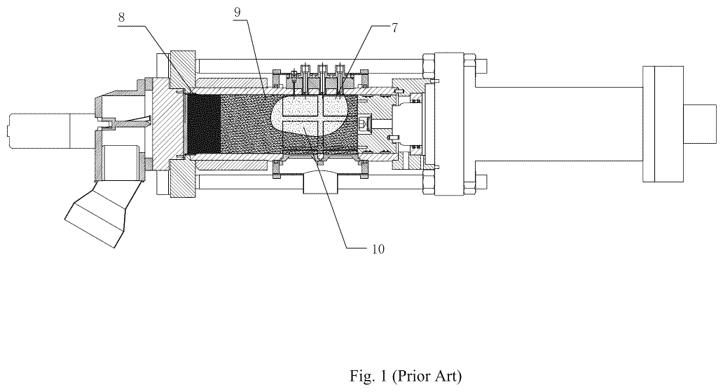

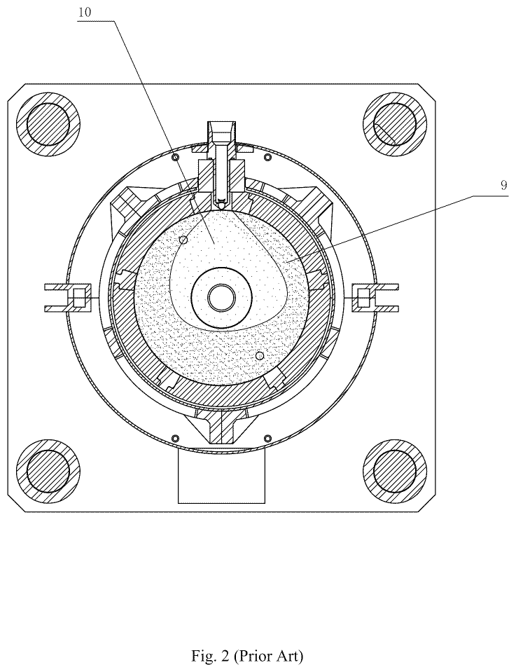

The ice preparation cavity 1 of the present disclosure is an existing technology. As shown in FIGS. 1 and 2, an outer wall of the ice preparation cavity 1 comprises a window 7, the window 7 is filled with a grid or low-density materials, and pores of the low-density materials or clearance of the grid are used to exhaust the carbon dioxide gas.

In ice preparation, the first inlet is in communication with the liquid outlet port 5 through the one or more ice injection valves 2. The liquid carbon dioxide flowing out of the liquid inlet pipeline 4 can be ejected from the liquid outlet port 5 to achieve a normal ice preparation process. Dry ice particles and the carbon dioxide gas are generated in the ice preparation cavity 1. The carbon dioxide gas can pass through the window 7 of the ice preparation cavity 1 initially, the dry ice particles will gradually block an air exhaust passage of the gird or the pores of the window 7, and the carbon dioxide gas will be retained in the ice preparation cavity 1. When the ice preparation is complete, the first inlet is blocked from the liquid outlet port 5 by the one or more ice injection valves 2 to stop ejecting the liquid carbon dioxide, and the air exhaust valve 3 is turned on to enable the liquid outlet port 5 to be in communication with the air exhaust port 6 through the air exhaust valve 3. In this way, during a forming process in which the dry ice particles are compressed by a piston in the ice preparation cavity 1, high-pressure carbon dioxide gas 10 will be exhausted from the air exhaust port 6. This air exhaust structure utilizes the liquid outlet port 5 as an inlet of air exhaust passage. Since the liquid outlet port 5 is always ejecting the liquid carbon dioxide during the ice preparation process, the liquid outlet port 5 will not be blocked by the dry ice particles. After ejection of the liquid carbon dioxide is stopped, the liquid outlet port 5 is used as the inlet of the air exhaust passage to ensure that the air exhaust passage will not be blocked.

An air exhaust method for dry ice preparation comprises the following steps:
1) enabling a liquid outlet port 5 to be in communication with the liquid inlet pipeline 4, ejecting liquid carbon dioxide into an ice preparation cavity 1 through the liquid outlet port 5, forming into dry ice particles using a part of the liquid carbon dioxide, and exhausting a part of carbon dioxide gas gasified from the liquid carbon dioxide from the window 7 of the ice preparation cavity 1 during ice preparation;
2) blocking the liquid outlet port 5 from the liquid inlet pipeline 4, and enabling the liquid outlet port 5 to be in communication with external air when the ice preparation process is complete; and
3) pushing a piston in the ice preparation cavity to compress the dry ice particles to form a shape, and discharging the carbon dioxide gas in the ice preparation cavity from the liquid outlet port 5.

The aforementioned embodiments are merely some embodiments of the present disclosure, and the conception of the disclosure is not limited thereto. Thus, it is intended that any non-substantive modifications of the present disclosure fall within the protective scope of the present disclosure provided they are made based on the conception without departing the present disclosure by any technical person skilled in the art.

What is claimed is:

1. A dry ice preparation device, comprising:
an ice preparation cavity,
one or more ice injection valves,
an air exhaust valve, and
a liquid inlet pipeline, wherein:
the one or more ice injection valves are disposed on a distal end of the liquid inlet pipeline and are configured to eject liquid carbon dioxide into the ice preparation cavity by turning on a liquid outlet port, and
the air exhaust valve is disposed between an air exhaust port and the liquid outlet port to enable the liquid outlet port to be in communication with external air through the air exhaust port.

2. The dry ice preparation device according to claim 1, wherein:
the one or more ice injection valves are at least two ice injection valves.

3. The dry ice preparation device according to claim 1, wherein:
the one or more ice injection valves and the air exhaust valve are connected to the liquid inlet pipeline through a three-way pipe.

4. The dry ice preparation device according to claim 3, wherein:
a first inlet of the three-way pipe is connected to the liquid inlet pipeline,
a second inlet of the three-way pipe is connected to the air exhaust valve,
an outlet of the three-way pipe is the liquid outlet port, and
the one or more ice injection valves are disposed between the first inlet and the liquid outlet port.

5. The dry ice preparation device according to claim 1, wherein:
an outer wall of the ice preparation cavity comprises a window,
the window is filled with low-density materials, and
the low-density materials comprise pores.

6. The dry ice preparation device according to claim 1, wherein:
an outer wall of the ice preparation cavity comprises a window, and
the window comprises a grid.

7. An air exhaust structure for dry ice preparation, wherein:
a liquid outlet port for ejecting liquid carbon dioxide is in communication with external air through an air exhaust valve.

8. The air exhaust structure for the dry ice preparation according to claim 7, comprising:
an ice preparation cavity,
one or more ice injection valves, and
a liquid inlet pipeline, wherein:
the one or more ice injection valves are disposed on the liquid inlet pipeline,
the liquid inlet pipeline is connected to an air exhaust port, and
the air exhaust valve is disposed between the air exhaust port and the liquid outlet port.

9. The air exhaust structure for the dry ice preparation according to claim 8, wherein:
the liquid outlet port and the air exhaust valve are connected to the liquid inlet pipeline through a three-way pipe.

10. The air exhaust structure for the dry ice preparation according to claim 9, wherein:
a first inlet of the three-way pipe is connected to the liquid inlet pipeline,
a second inlet of the three-way pipe is connected to the air exhaust valve,
an outlet of the three-way pipe is the liquid outlet port, and
the one or more ice injection valves are disposed between the first inlet and the liquid outlet port.

11. The air exhaust structure for the dry ice preparation according to claim 8, wherein:
an outer wall of the ice preparation cavity comprises a window,
the window is filled with low-density materials, and
the low-density materials comprise pores.

12. The air exhaust structure for the dry ice preparation according to claim 8, wherein:
an outer wall of the ice preparation cavity comprises a window, and
the window comprises a grid.

13. An air exhaust method for dry ice preparation, comprising:
1. enabling a liquid outlet port to be in communication with a liquid inlet pipeline, and ejecting liquid carbon dioxide into an ice preparation cavity through the liquid outlet port to obtain dry ice particles during dry ice preparation; and
2) blocking the liquid outlet port from the liquid inlet pipeline, enabling the liquid outlet port to be in communication with external air, and pushing a piston in the ice preparation cavity to compress the dry ice particles to form a shape when the dry ice preparation is complete.

14. The air exhaust method of the dry ice preparation according to claim 13, wherein:
exhausting carbon dioxide gas gasified by the liquid carbon dioxide from a window of the ice preparation cavity during the dry ice preparation.

15. The dry ice preparation device according to claim 4, wherein:
an outer wall of the ice preparation cavity comprises a window,
the window is filled with low-density materials, and
the low-density materials comprise pores.

16. The dry ice preparation device according to claim 4, wherein:
an outer wall of the ice preparation cavity comprises a window, and
the window comprises a grid.

17. The air exhaust structure for the dry ice preparation according to claim 9, wherein:
an outer wall of the ice preparation cavity comprises a window,
the window is filled with low-density materials, and
the low-density materials comprise pores.

18. The air exhaust structure for the dry ice preparation according to claim 9, wherein:
an outer wall of the ice preparation cavity comprises a window, and
the window comprises a grid.
